(19) United States
(12) Patent Application Publication
(10) Pub. No.: US 2020/0190794 A1
(43) Pub. Date: Jun. 18, 2020

(54) STRUCTURAL BONDING SYSTEM

(71) Applicant: David Anthony Clephane, Mount Pleasant (NZ)

(72) Inventor: David Anthony Clephane, Mount Pleasant (NZ)

(21) Appl. No.: 16/796,544

(22) Filed: Feb. 20, 2020

Related U.S. Application Data
(62) Division of application No. 16/086,937, filed on Sep. 20, 2018.

(30) Foreign Application Priority Data
Mar. 30, 2016 (NZ) 718477

(51) Int. Cl. E04B 2/72; E04F 11/18; C03C 27/00; E04C 2/54

(52) U.S. Cl. CPC E04B 2/721; E04F 11/1812; C03C 27/00; E04F 2011/1895; E04F 11/1853; E04B 2103/02; E04C 2/54

(57) ABSTRACT

A method of bonding a structural component to a building, including the steps of: (i) receiving a structural component including an attachment zone constituting at least 10% of the total surface area of one side of the structural component, wherein the attachment zone has been prepared according to a method including the steps of: a. applying a frit to the attachment zone; and b. tempering the structural component so as to bond the frit to the structural component; (ii) providing a building engagement face at least coextensive with the attachment zone of the structural component; (iii) applying a bonding sealant to a majority of at least one of the attachment zone or the building engagement face; and (iv) engaging the bonding sealant with the other of the attachment zone or the building engagement face.

### TECHNICAL FIELD

The present invention relates to a system and method of installing structural components in a building, especially structural components made of glass.

### BACKGROUND

Any discussion of the prior art is not an admission that such art forms part of the common general knowledge in the field.

As used herein, the term “building” includes any fixed structure, and a part of a building or fixed structure.

Glass has traditionally been used in buildings as a window material. Glass panes can be secured into frames made of wood or metal (e.g. aluminium) by means including the use of putty, elastomeric seals, and silicone sealant compounds. The window usually engages with the frame around its entire periphery, to prevent point stresses which might cause the glass to shatter under pressure.

Glass can also be used for structural components of a building, such as glass walls, balustrades, or roofing systems.

One method by which structural glass components can be secured to the underlying structure of the building is by making holes in the glass, passing fastening means such as bolts through the holes, to engage with the structure and hold the glass in place. Drilling toughened or reinforced glass to make the holes can be difficult and time consuming. Holes can be made in the raw annealed glass before tempering, but this then prevents any later amendments to the design. The mounting system is constrained by the potential location of the holes.

To overcome the difficulties with hole-based mounting systems, non-penetrative clamping systems have been designed, such as the “Glass Vice” system described in NZ 556329. This disclosed the use of clamp jaws defining an elongate slot for receiving an edge of a panel, a base, and fasteners, acting together to clamp the panel to hold it in the slot.

When glass is chosen as a building material, this indicates that a high degree of visibility is desired. Mounting systems are therefore designed to minimise their visual impact. This was recognised in NZ 596115, which describes a non-penetrative fastening system for mounting a panel to a side of the structure such that at least a portion of the panel extends above a top surface of the structure.

Silicone sealants are available for structural applications, such as Dow Corning® 121 Structural Glazing Sealant, which is a two-part silicone formulation designed specifically for use in structural glazing applications in field and factory applications. Once catalysed, the material cures into a medium-modulus, flexible silicone rubber that is flexible for use in structural and weatherseal applications. However, a general warranty of suitability for such applications is not provided; instead, a project specific structural adhesive warranty will only be issued after an application has been reviewed by technical staff at Dow Corning Corporation.

Before a silicone sealant can be used, the surface of the glass must be carefully prepared by cleaning all joints, removing all foreign matter and contaminants such as grease, oil, dust, water, frost, and surface dirt. This can be difficult to achieve on a building site, so that it is sometimes necessary to pre-bond the glass off-site in a sterile, enclosed, environment.

It is an object of the present invention to provide a structural bonding system that will overcome one or more of the deficiencies with the existing systems described above, and/or provide the public with a useful choice.

### DISCLOSURE OF INVENTION

Therefore the present invention provides a method of bonding a structural component to a building, including the steps of:
(i) receiving a structural component including an attachment zone constituting at least 10% of the total surface area of one side of the structural component, wherein the attachment zone has been prepared according to a method including the steps of:
   a. applying a frit to the attachment zone; and
   b. tempering the structural component so as to bond the frit to the structural component;
(ii) providing a building engagement face at least coextensive with the attachment zone of the structural component;
(iii) applying a bonding sealant to a majority of at least one of the attachment zone or the building engagement face; and
(iv) engaging the bonding sealant with the other of the attachment zone or the building engagement face.

In a preferred embodiment, the attachment zone constitutes at least 22% of the total surface area of one side of the structural component.

Preferably the bonding sealant is applied to at least 90% of the attachment zone.

In a preferred embodiment, the structural component is made of glass. Preferably the tempering step is carried out to 90 mega-pascals (MPa). More preferably the tempering step is carried out to 130 to 160 MPa.

Preferably the building engagement face is steel; more preferably a 10 millimetre (mm) thick steel plate. Alternatively, the building engagement face may be glass, timber, concrete, or a composite material.

The present invention further provides for a structural component of a building, bonded according to the method described above.

The present invention further provides for the combination of a structural component including an attachment zone constituting at least 10% of the total surface area of the structural component, wherein the attachment zone has been prepared including the steps of:
a. applying a frit to the attachment zone; and
b. tempering the structural component so as to bond the frit to the structural component;
   and a bonding sealant.

### BRIEF DESCRIPTION OF THE DRAWINGS

By way of non-limiting example only, a preferred embodiment of the invention is described in detail below with reference to the accompanying drawings, in which:

FIG. 1 is a plan view of a preparatory stage of a structural component according to the present invention;

FIG. 2 is a side view of a structural component bonded to a building according to the present invention; and

FIGS. 3a & 3b are side views of alternative embodiments of a building bonded to a structural component according to the present invention.

### BEST METHOD OF PERFORMING THE INVENTION

A preferred embodiment of the present invention is described with reference to the accompanying drawings as a system of bonding a glass balustrade on to a horizontal part a building, such as a balcony or mezzanine floor, to create a structure which is fully compliant with the New Zealand Building Code clause for Structure, B 1.

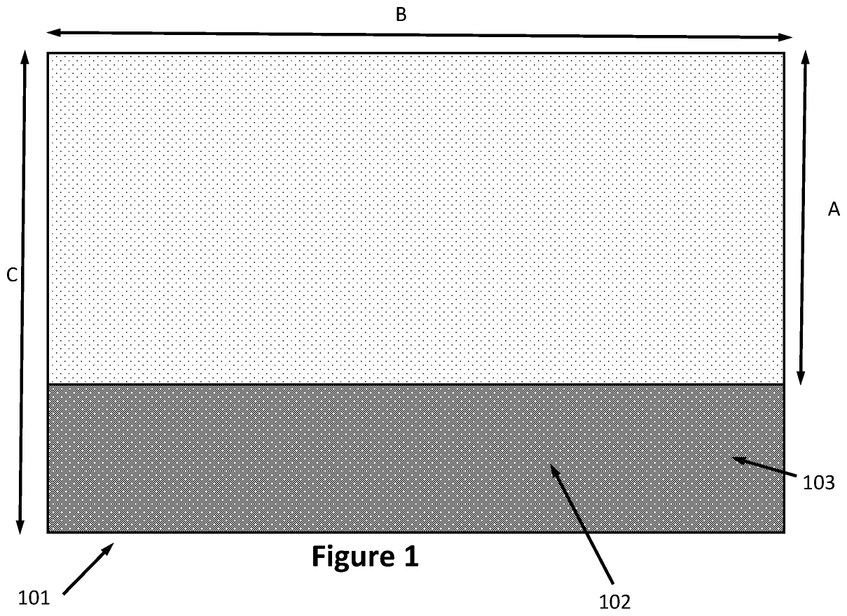

A glass balustrade is designed to extend a functional height A above the floor level of a part of a building, such as a balcony or mezzanine floor. The balustrade is to extend from the edge of the floor along a length B. As shown in FIG. 1, a piece of annealed glass 101 (preferably 15 mm thick) is prepared for the designed shape of the balustrade, having a length B, and a glass height C. In this preferred embodiment, glass height C is at least 22% greater than functional height A.

An attachment zone 102 of the annealed glass 101 is the area of glass which will be below the functional height A of the annealed glass 101, as shown in FIG. 1. In this preferred embodiment, attachment zone 102 constitutes at least 22% of the total area of annealed glass 101. It is believed an attachment zone constituting as little as 10% of the total surface area may be sufficient for the present system.

A frit 103 is then applied to the entire attachment zone 102 of the annealed glass 101. The colour of the frit may be selected for aesthetic effect, or multiple colours may be used to print a design, but the whole attachment zone 102 must be covered. Glasshape®'s DIP SPECTRUM™ inks, which provide a glass enamel primarily consisting of SiO₂, ZnO, B₂O₂, Na₂O and BiO₂, have been found to work well for this purpose.

Utilising the method of the present invention, it is not necessary to make any holes in annealed glass 101 for securing the glass to the building. However, as will be apparent to one skilled in the art, the annealed glass 101 may also be prepared so as to engage with other components, such as hand rails, which may optionally be selected to be attached to the finished balustrade, according to other design factors.

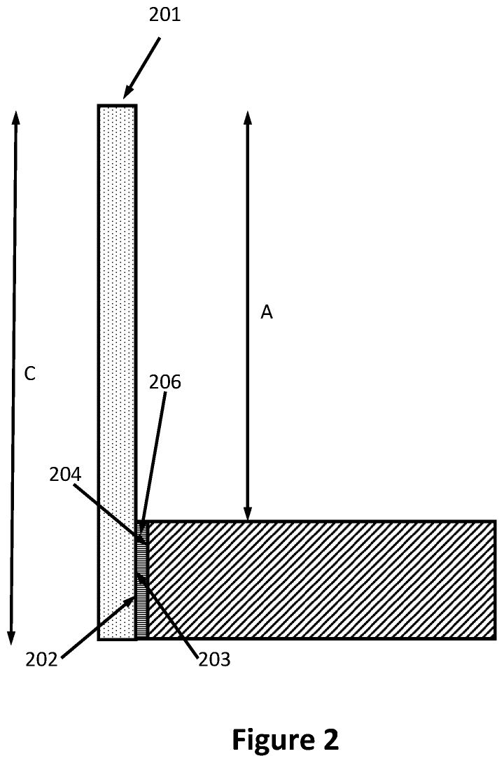

After the frit 103 has been applied, the annealed glass 101 is tempered. The glass is heated to about 615° C. (degrees Celcius), then rapidly cooled by forced air flow. This strengthens the glass and makes it about 4 to 5 times stronger than normal glass. For use as a balustrade, the 30o annealed glass 101 should be tempered to 160 MPa (rather than the standard 90 MPa), to become tempered glass 201, shown in FIG. 2.

During the tempering process, the frit 103 becomes bonded to tempered glass 201, to form a frit engagement face 203 throughout attachment zone 202.

The building needs to include a building engagement face 204, which must be at least coextensive with attachment zone 202.

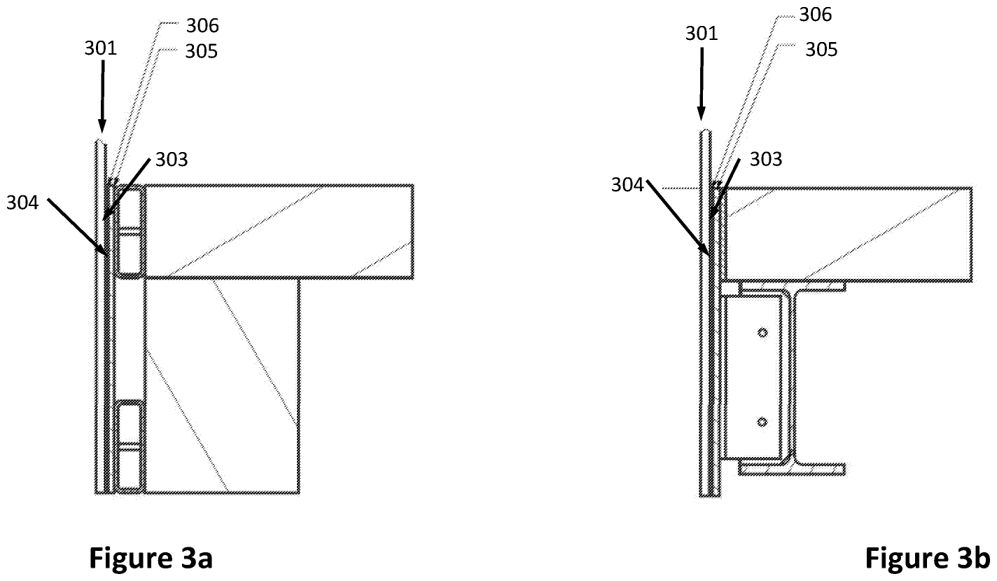

In trials, a 10 mm thick plate of G250 steel (a galvanised mild steel with a minimum yield strength of 250 MPa) has been found to provide an appropriate building engagement face 204. Optional embodiments shown in FIGS. 3a and 3b show two ways of mounting a steel plate 305 on the building, to provide a building engagement face 304 for bonding to the frit engagement face 303 of tempered glass 301 using bonding sealant 306. The mounting means for steel plate 305 shown in FIGS. 3a and 3b are examples only, and one skilled in the art would be aware of other ways in which an appropriate building engagement face 204 could be provided.

In this example, building engagement face 204 is steel. However, another substrate such as glass, timber, concrete, or a composite material, could be used to provide an appropriate building engagement face 204.

The tempered glass 201 is brought to the building site and prepared for bonding. Both the frit engagement face 203 and the building engagement face 204 are cleaned, but it has surprisingly been found that, unlike conventional sealing methods, it is not necessary to remove all foreign matter and contaminants, such as grease, oil, dust, water, frost, surface dirt etc before bonding using the present system.

In this preferred embodiment, a bonding sealant 206 is a structural glazing sealant. Bonding sealant 206 is prepared, and is placed to substantially cover the frit engagement face 203, which is then brought into position so that bonding sealant 206 is held between frit engagement face 203 and building engagement face 204, substantially filling the space between them. Standard clamping or support means can then be used to hold frit engagement face 203 and building engagement face 204 in their respective positions adjacent bonding sealant 206 until bonding sealant 206 has cured.

Unlike traditional bonding methods, which require engagement of multiple edges of the glass panel, it has surprisingly been found that bonding across substantially all of the frit engagement face 203 creates a sufficiently strong engagement between the tempered glass panel 201 and the building engagement face 204 that a balustrade constructed according to the preferred embodiment would meet the requirements for a C5 barrier, suitable for use in crowd loaded situations.

The present embodiment provides for an unobstructed view through tempered glass panel 201 for the entire height A above the building structure. In alternative embodiments, handrails may be included, or a digital print or other decorative feature may cover part or all of the panel. The frit can also be selected to meet an aesthetic requirement, and because the bonding area is the frit engagement area, the means of attachment of the tempered glass panel 201 to the building engagement face cannot be seen.

The embodiments shown and described in detail herein are by way of example only. The present invention is intended to include such modifications and variations thereto as may be obvious to one skilled in the art.

1. (canceled)

2. (canceled)

3. (canceled)

4. (canceled)

5. (canceled)

6. (canceled)

7. (canceled)

8. (canceled)

9. A structural component of a building, bonded according to the method according to claim 1.

10. The combination of:
(i) a structural component for a building including an attachment zone constituting at least 10% of the total surface area of one side of the structural component, wherein the attachment zone has been prepared including the steps of:
a. applying a frit to the attachment zone; and
b. tempering the structural component so as to bond the frit to the structural component; and
(ii) a bonding sealant.

11. The combination according to claim 10, wherein the structural component is made of glass.

12. The combination according to claim 11, wherein the tempering step is carried out to 90 MPa.

13. The combination according to claim 10, wherein the attachment zone constitutes at least 22% of the total surface area of one side of the structural component.

14. The combination according to claim 10, wherein the tempering step is carried out to 90 MPa.
